(19) United States
(12) Patent Application Publication
(10) Pub. No.: US 2015/0325143 A1
(43) Pub. Date: Nov. 12, 2015

(54) Micro-Coaching for Healthy Habits

(71) Applicant: Rise Labs, Inc., San Francisco, CA (US)

(72) Inventors: Suneel Kumar Gupta, San Francisco, CA (US); Stuart J. Parmenter, San Francisco, CA (US)

(21) Appl. No.: 14/709,352

(22) Filed: May 11, 2015

Related U.S. Application Data
(60) Provisional application No. 61/991,113, filed on May 9, 2014.

(51) Int. Cl. G09B 19/00; G09B 5/02

(52) U.S. Cl. CPC G09B 19/0092; G09B 5/02; G09B 19/00

(57) ABSTRACT

A platform and application provide for micro-coaching on healthy eating and lifestyle. Clients log meals using a mobile application by taking a picture of the meal and/or optionally describing the meal using text. Clients may also log workouts, exercise, and activity details. The client's coach can view the logs in the client's activity log and add a comment. The coach's comment on a logged meal may be displayed in association with the meal in the client's activity log. Optionally, the client can reply to the coach's comment, and the reply is displayed in the same meal message thread. Accordingly, the platform and application enable the client to conveniently log meals, exercise, and activity data and obtain feedback from a coach on a meal or exercise log.

### CROSS REFERENCE TO RELATED APPLICATIONS

This application is a continuation of U.S. Provisional Application No. 61/991,113, filed May 9, 2014, the contents of which are hereby incorporated by reference in its entirety.

### BACKGROUND

1. Field of Disclosure

This disclosure relates to a platform and application for coaching related to healthy eating habits and lifestyle.

2. Description of the Related Art

Many tools exist for helping people develop and maintain healthy eating habits. One basic tool is a food log that acts as a record of all foods that are consumed by a person. Conventionally, food logs can be prepared using a pen and paper or electronically through a website or software application. One barrier to a more widespread adoption of food logs is how tedious they are to keep up to date. Applications that require users to separately enter every food and every quantity consumed are time consuming and cumbersome. Yet without consistent logging, it is not possible to analyze a person's nutritional intake.

Another tool for helping people develop and maintain healthy eating habits and lifestyle is personal coaching. Conventionally, coaches periodically meet with clients to provide feedback on clients' food logs and/or other measures of the user's health or habits. Typically, the coach's opportunities to provide personalized feedback are constrained to the client's appointed session with the coach. Further, traditional coaching sessions may be prohibitively expensive for the average person. As a result of these challenges, personal coaching on healthy eating as it has been implemented in the past may not be meeting people's needs.

### SUMMARY

Embodiments of the invention provide a platform and application provide for micro-coaching on healthy eating and lifestyle. Clients log meals using a mobile application by taking a picture of the meal and/or optionally describing the meal using text. Clients may also log workouts, exercise, and activity details. The client's coach can view the logs in the client's activity log and add a comment. The coach's comment on a logged meal may be displayed in association with the meal in the client's activity log. Optionally, the client can reply to the coach's comment, and the reply is displayed in the same meal message thread. Accordingly, the platform and application enable the client to conveniently log meals, exercise, and activity data and obtain feedback from a coach on a meal or exercise log.

Embodiments of the computer-readable storage medium store computer-executable instructions for performing the steps described above. Embodiments of the system further comprise a processor for executing the computer-executable instructions.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 is a high-level block diagram illustrating an embodiment of a platform environment for micro-coaching for healthy eating habits and lifestyle.

FIG. 2 is a block diagram illustrating an information presentation module according to one embodiment.

FIG. 3 is a high-level block diagram illustrating an example computer for implementing the entities shown in FIG. 1.

FIG. 4 is a diagram illustrating the interaction between the client, server, and coach, according to one embodiment.

FIG. 5 is a set of user interface examples that illustrate logging a meal, in accordance with an embodiment.

FIG. 6 is another example user interface illustrating an activity log before a client has logged a meal, in accordance with an embodiment.

FIG. 7 is another example user interface for selecting a photo to represent a meal to be logged by the client, in accordance with an embodiment.

FIG. 8 is another example user interface for entering a text description associated with a meal logged by the client, in accordance with an embodiment.

FIG. 9 is another example user interface illustrating the meal logged by the client, in accordance with an embodiment.

FIG. 10 is another example user interface illustrating a coach's view of the meal logged by the client as described with reference to FIGS. 7-9, in accordance with an embodiment.

FIG. 11 is another example user interface for a coach to enter feedback on the client's logged meal, in accordance with an embodiment.

FIG. 12 is another example user interface illustrating the client's view of the coach's feedback on the client's logged meal, in accordance with an embodiment.

The Figures (FIGS.) and the following description describe certain embodiments by way of illustration only. One skilled in the art will readily recognize from the following description that alternative embodiments of the structures and methods illustrated herein may be employed without departing from the principles described herein.

### DETAILED DESCRIPTION

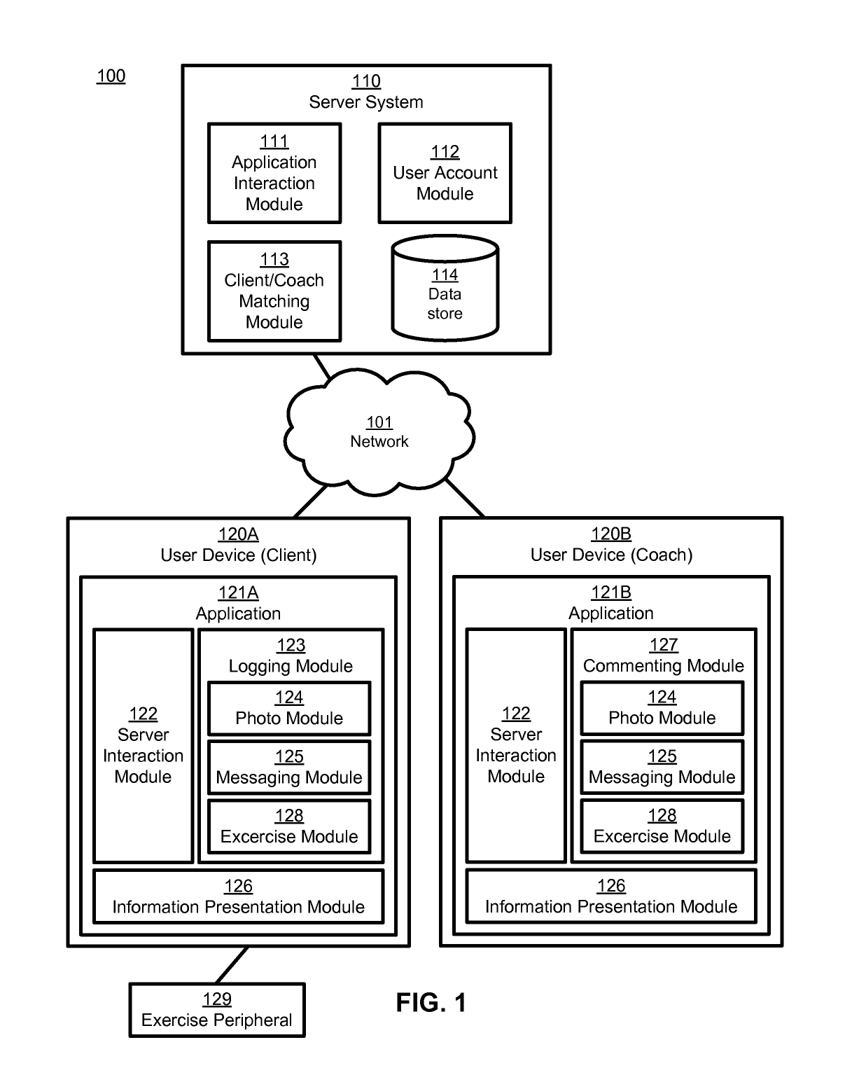

FIG. 1 is a high-level block diagram illustrating an embodiment of a platform environment 100 for micro-coaching for healthy eating habits and lifestyle. The platform environment 100 includes a server system 110, a client's user device 120A, and a coach's user device 120B connected by a network 101. Only one server system 110, one client's user device 120A, and one coach's user device 120B are illustrated, but in practice there may be multiple instances of each of these entities. For example, there may be thousands or millions of user devices 120 in communication with several or many server systems 110.

The server system 110 authenticates user devices 120, matches clients with coaches, and stores user data, and enables messages to be exchanged between coaches and clients related to meals that are logged by clients. In some embodiments, the server system 110 is implemented as a single server, while in other embodiments it is implemented as a distributed system of multiple servers. The server system 110 includes an application interaction module 111, a user account module 112, a client/coach matching module 113, and a data store 114.

The application interaction module 111 manages the interactions between the server system 110 and the user devices 120. The application interface module 111 receives logs from a user, updates a unified log to incorporate the newly received logs, and sends the updated log to the coach. The logs may contain information about a meal, such as a picture of a meal or a user generated text description of the meal. The logs may also contain exercise logs which specify a workout routine, with details such as duration of the workout, amount of weight lifted, distance, or change in altitude. The logs may also contain activity data (e.g., number of hours spent sitting or inactive during a day, distance walked during a day, or number of steps taken during a day). The application interaction module 111 may update the client's activity log in response to receiving a new log from the client, and communicates the updated activity log to the coach's user device 120B. The application interaction module 111 also updates the client's activity log in response to receiving comments exchanged between the coach and the client. These comments can be specifically associated with a certain item in the activity log (e.g., a specific thread of comments may be associated in the activity log with a logged meal).

The user account module 112 receives user credentials to authenticate a user to the server system 110 and enable access to the user's stored data. The user account module 112 may also store user preferences, user profile information, billing information, and other administrative data for each respective account.

The client/coach matching module 113 matches each client to a coach. In one embodiment, the coach is randomly assigned. In some embodiments, details about the client, which may be stored by the user account module 112, are considered in matching the client to an appropriate coach. Details about the client may include the client's personality, behavioral style, personal characteristics (such as gender, age, and ethnicity), health profile (such as presence of heart disease, high cholesterol, high blood pressure, diabetes, hormonal issues, pregnancy, or food intolerances or sensitivities), lifestyle (such as level of activity, amount of business travel, and training schedule), and/or goals (such as losing weight, gaining weight, eating a paleo, vegan, vegetarian, or low-carb or low-sugar diet). The details about the client may be input by the client via a survey interface. The appropriate coach may have compatible interests, related experience, or a proven track record in assisting similar clients in the past. The coach's experience, credentials and qualifications may be self-reported in some instances (e.g., through surveys, resumes, profiles, or the like) or may be verified in other instances (e.g., through transcripts, professional references, client testimonials, or the like). In one implementation, the client/coach matching module 113 considers the client's preferences and needs in addition to a coach's record of success in working with similar clients on the platform. The client/coach matching module 113 may generate a set of coaches with availability for a new client from which a client may be offered a choice with whom to work. In one embodiment, each client works with only one coach, although in some cases, several clients may be separately working with the same coach. In an alternate embodiment, some clients may be coached by more than one person, for example to receive a diversity of tips for improving their eating habits or to receive targeted feedback in two specialty areas of different experts (e.g., increasing protein consumption, and nutrition for endurance athletes).

The client/coach matching module 113 can be configured to establish a compatibility score between a coach and a client used to generate the set of coaches. This compatibility score can be based, at least in part, on the past successes of a coach with other clients who are similar to the client. For example, if a client is diabetic, then a coach's history of success with diabetic clients may be considered in the compatibility score. The history of success can be quantified by considering the retention rates of clients, client progress towards goals (e.g., in terms of weight lost or gained), or the feedback of clients (e.g., comments or a rating system). The client/coach matching module 113 may also assign weights to different characteristics of a client to quantify their relative importance in generating the compatibility score. For example, the client/coach matching module 113 might consider a client who has a gluten allergy and is a long distance runner and assign a weight of 0.4 to the client's characteristic of having a gluten allergy and a weight of 0.6 to the client's characteristic of being a long distance runner. In this example, a coach's success with long distance runners will be weighed more heavily than their success with people with gluten allergies when generating the compatibility score. In some embodiments, these weights are generated by the client/coach matching module 113 by considering the correlation between a certain client characteristic and success metrics via a statistical analysis of a group of clients and coaches. In some embodiments, the weights are generated from the client's selections from a list of attributes to be considered when calculating the compatibility score for coaches (e.g. a client can choose to be matched with coaches who were successful with clients who are vegetarians). The relative compatibility scores of the available coaches can determine or be a factor in the matching of the client/coach matching module 113.

The data store 114 of the server system 110 stores user data for distribution to user devices 120. The user data may be, for example, data collected by the user account module 112, such as user preferences, user profile information, billing information, and other administrative data for each respective account, as well as the user's activity log including logged meals, messages exchanged between the client and the coach, logged exercise details, and logged activity details.

The user device 120A operated by the client is a computing device, such as a desktop, laptop, or tablet computer, or a smart phone or other mobile computing device. The user device 120A is used by the client to log meals and receive coaching feedback on their logged meals. The user device 120A executes an application 121A.

The application 121A is a software application, for example running within the operating system of the user device 120A. The software application contains program modules to implement the functionality described herein. Specifically, as illustrated in this example, the application 121A includes a server interaction module 122; a meal logging module 123 which includes a photo module 124, a messaging module 125, an exercise log module 128, and an information presentation module 126.

The server interaction module 122 of the application 121A manages the interactions of the application 121 with the server system 110. The server interaction module 122 communicates data between the user device 120 and the server system 110 via the network 101. The server interaction module 122 relays logged meals to the server system 110 and messages exchanged between the client and the coach.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the server system 110 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the server system 110.

The meal logging module 123 of the application 121A allows the client to log meals by uploading one or more photos of the meal via the photo module 124 or typing a description of the meal via the messaging module 125. By enabling the client to conveniently log entire meals using a visual interface, the client can quickly capture relative quantities of foods, the color of foods which may signal nutritional content, and enable a viewer to quickly grasp the client's meal composition. Text descriptions can be used by the client to make notations about the meal, including providing additional information to disambiguate foods that are similar in appearance, or specify further details about the meal that are not visually apparent (such as amount of salt added, the source of the food, etc.). Additional information, such as the client's location as collected by a GPS receiver, can be included along with the photo. Location data can allow identification of a location (e.g., restaurant, home, etc.) by the meal logging module 123 or by the coach. The client can decide whether to include location data each time the client is uploading a photo, or by a user-configurable setting available in the application 121A. In some embodiments, the location data provided to the coach comprises a restaurant name or details about the restaurant, without providing a geographic location. A user can alternately provide a restaurant name along with the photo by selecting from a list or searching a database of restaurants.

Exercise Module 128 allows the user to log exercise data. The data can be collected via a connection to an exercise peripheral 129. The exercise peripheral 129 can be a wearable device such as a fitness band or smartwatch coupled to the user device 120A via a wireless communication protocol. The exercise module 128 can also collect data via systems on the user device 120A, such as a pedometer or a GPS receiver, from an application on the user device 120A, or from an API on the user device 120A. The exercise module 128 can also allow a user to input exercise data manually or allow the user to comment on the exercise data via the messaging module 125.

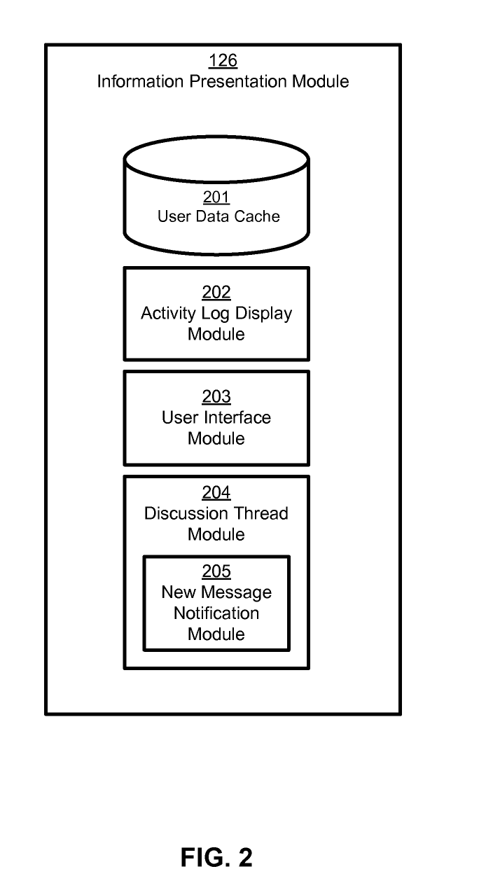

The information presentation module 126 formats the logged meals and messages exchanged between the client and the coach for presentation on the user device 120 in an activity log. The information presentation module 126 will be described in greater detail below with reference to FIG. 2.

The user device 120B operated by the coach is a computing device, such as a desktop, laptop, or tablet computer, or a smart phone or other mobile computing device. The user device 120B is used by the coach to review a client's logged meals and activity logs and to provide coaching feedback on them, including asking and answering follow up questions directed to improving the client's healthy eating habits. The user device 120B executes an application 121B.

The application 121B is a software application, for example running within the operating system of the user device 120B, and is similar to many respects to the application 121A described above. The software application contains program modules to implement the functionality described herein. Specifically, as illustrated in this example, the application 121B includes a server interaction module 122; a commenting module 127 which includes a photo module 124, a messaging module 125, and an exercise module 128; and an information presentation module 126. The server interaction module 122 and the information presentation module 126 operate as described above with reference to application 121A.

The commenting module 127 enables the coach to provide feedback on the meal logged by the client through the photo module 124 or the messaging module 125. The commenting module 127 also enables the coach to provide feedback on exercise data received through the exercise module 128. In many cases, the coach's feedback is input via the messaging module 125, for example the coach inputs comments on the food choices that the client has made and provides suggestions of alternatives to try in the future. In some cases, the coach may upload an image through the photo module as part of the feedback, for example an image of the packaging of an alternate food product that is recommended by the coach or an image of a prepared recipe that the coach wants the client to try.

The commenting module 127 allows a coach to evaluate a log with respect to a goal. For example, a coach may evaluate a meal log as to whether the meal log meets the goal of being less than 1000 Calories. The goal may be set by the coach or by the client. The logs may be evaluated individually (e.g., every meal log is evaluated). Alternately, the goals may be evaluated on a daily basis or a weekly basis. For example, a weekly goal for a client may be determined by net Calories, wherein consuming food adds to the net Calories and exercise and activity subtracts from the net Calories. If, at the end of a weekly period, the clients net Calories are less than a certain number than the client might receive feedback that indicates that the client has met the goal. The evaluation may be done by the coach or automatically based on the coach's evaluation of the Caloric value for each of the client's meals, exercise sessions, and activity logs. Goals can take other forms as well, such as miles run or biked, whether a meal conformed to a certain diet, and time spent exercising.

The network 101 provides a communication infrastructure between the server system 110 and the client devices 120. The network 101 is typically the Internet, but may be any network, including but not limited to a Local Area Network (LAN), a Metropolitan Area Network (MAN), a Wide Area Network (WAN), a mobile wired or wireless network, a private network, or a virtual private network.

Although, FIG. 1 shows a single coach—user pair, alternate configurations may also be used to include additional user or coach pairings. For example, each client can be assigned to a single coach. Alternately, a group of clients can be assigned to a coach or a group of coaches. In some embodiments, clients in a group can communicate among themselves or view updates, progress, or other statistics from another client in the group. A client can have multiple coaches and may select which coach to send meal photos, exercise data, comments, or questions to, or this selection can be done automatically or based on settings configurable by the client or a coach. For example, a client can send photos of their meal to one coach and send details regarding workouts to a second coach. Alternately, the client can be assigned to multiple coaches, wherein each of the coaches receives the same update from the client, so that a client can receive updates more quickly or more reliably, or updates can be sent to each coach based on the day of the week, which can allow a user to receive feedback every day of the week, while allowing for coaches with limited availability.

FIG. 2 is a block diagram illustrating an information presentation module of the application 121 according to one embodiment. The information presentation module 125 includes a user data cache 201, an activity log display module 202, a user interface module 203, and a discussion thread module 204, which includes a new message notification module 205.

The user data cache 201 stores user data collected from the client and/or coach or received from the server system 110. The user data cache 201 stores the meals recently logged by the client and the messages exchanged between the client and coach regarding those meals. The user data cache 201 may store both data that have been communicated from the server system 110 in preparation to be shown to the user as well as data that has recently been presented to the user.

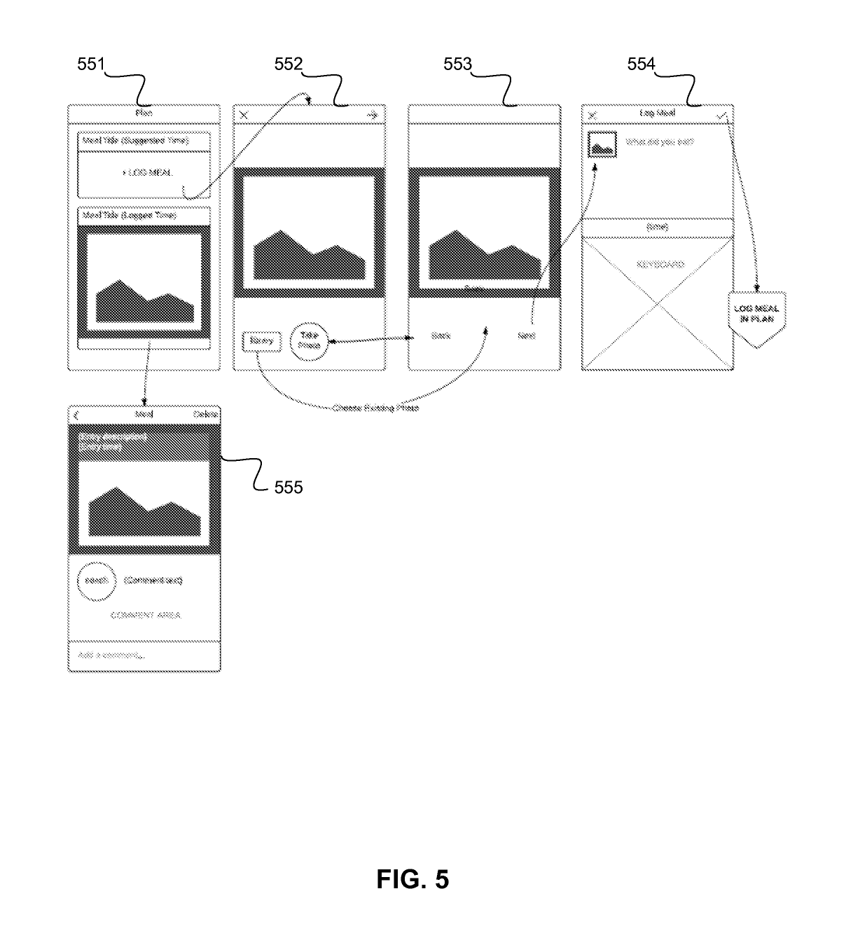

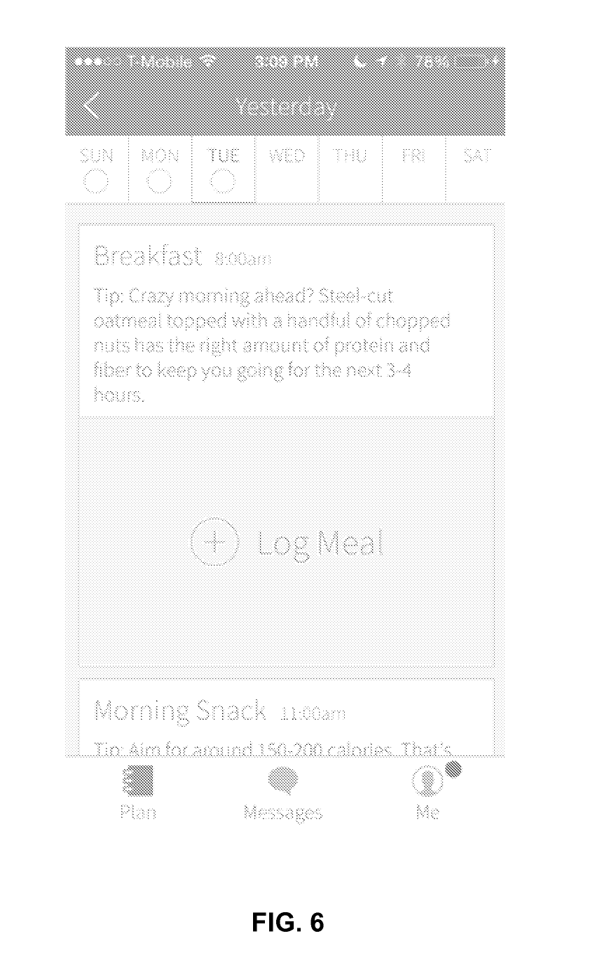

The activity log display module 202 retrieves data from the user data cache 201 and formats the data as a client activity log. In one embodiment, the client activity log is divided into days of the week, which can be displayed with a calendar interface. Each day of the week is further divided into frames. A frame may correspond to a meal or snack in chronological order through the day. A frame may also contain details for a workout session or details about the client's general activity for a day. A frame that corresponds to a meal or snack may contain an image of the meal or snack, any corresponding description of the meal or snack, and any discussion thread corresponding to the meal or snack. For example, the activity log may include vertical list of frames including a breakfast frame, a morning snack frame, a lunch frame, an afternoon snack frame, a dinner frame, and an evening snack frame. In other examples, the numbers and timing of meal and snack frames may differ according to the healthy eating goals of the client and/or the recommendations of the coach. The activity log frames have a width and a length, which may be sized appropriately for display on the screen of the respective user device 120. For example, the width of a frame may be slightly less wide that the width of the screen of the user device 120, and the length of a frame may be sized to display the entire frame on the screen of the client device 120 without scrolling. The activity log may begin the day with empty frames before they are populated to the client logging their meals. Examples of frames within a client activity log are illustrated in FIGS. 5 and 6, described below. Other organizations and formats of the client activity log, including logging meals and receiving feedback, may also be used. A day of the week can also contain a frame that contains exercise goals or a log of exercise. A day can also include a frame that includes comments from a coach. In some instances, items described above are implemented in a single interface layout within one screen, and in other instances are distributed among several screens through which the user navigates to log meals and receive feedback.

The user interface module 203 interprets the user's interaction with the client device 120 and makes corresponding changes to the display of the client's activity log on the screen of the user device 120. For example, in response to a user's scrolling down gesture, the user interface module 203 may cause the next frame of the activity log to appear below the currently displayed frame on the screen of the user device 120. Other examples of the user's selections through the user interface of the application 121 are described with reference to FIG. 5.

The discussion thread module 204 of the information presentation module 126 organizes the messages exchanged between the client and the coach as a discussion thread. The discussion thread module 204 places all messages between the client and coach in response to a single meal within the same thread and orders these messages chronologically, so that they can be easily read in the proper context. The discussion thread module 204 may include a new message notification module 205 that notifies a user when a new message has been added to any discussion thread. Because the client and the coach may add comments asynchronously and respond to previous comments at any time, a new message notification ensures that the client and coach are made aware of recent updates and do not overlook the newest contributions of the other party.

In some embodiments, clients and coaches may receive push notifications sent to their user devices 120 to notify them of new postings from their coach or client(s), respectively. The push notifications may be implemented and delivered according to any technique known to those of skill in the art, such as through the Apple Push Notification Service available through iOS, which can be used to forward alerts from the server system 110. Push notifications can be used as a convenience to clients and coaches who post updates asynchronously, but want to be informed of the latest activity with respect to a client's activity log or more generally the user's account. In some embodiments, the client and coach may communicate via an instant messaging system or through a synchronous communication system, such as a video chat.

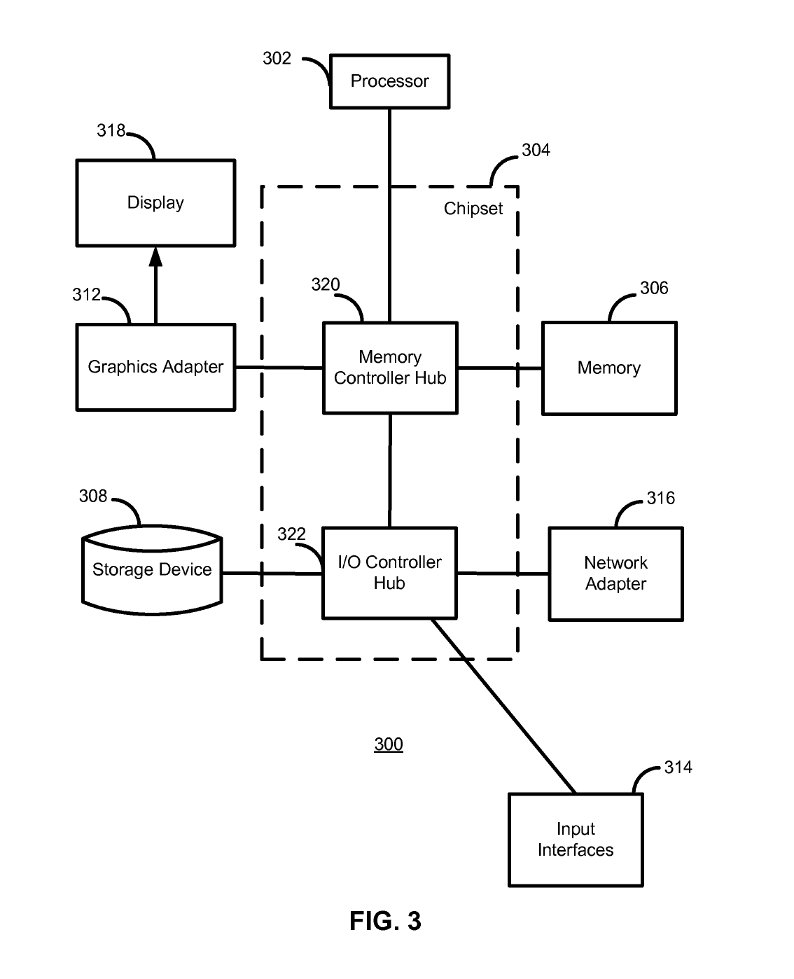

FIG. 3 is a high-level block diagram illustrating an example computer for implementing one or more of the entities shown in FIG. 1. The computer 300 includes at least one processor 302 coupled to a chipset 304. The chipset 304 includes a memory controller hub 320 and an input/output (I/O) controller hub 322. A memory 306 and a graphics adapter 312 are coupled to the memory controller hub 320, and a display 318 is coupled to the graphics adapter 312. A storage device 308, an input device 314, and network adapter 316 are coupled to the I/O controller hub 322. Other embodiments of the computer 300 have different architectures.

The storage device 308 is a non-transitory computer-readable storage medium such as a hard drive, compact disk read-only memory (CD-ROM), DVD, or a solid-state memory device. The memory 306 holds instructions and data used by the processor 302. The input interfaces 314 may include a touch-screen interface, a mouse, track ball, or other type of pointing device, a keyboard, or some combination thereof, and is used to input data into the computer 300. In some embodiments, the computer 300 may be configured to receive input (e.g., commands) from the input interface 314 via gestures from the user. Gestures are movements made by the user while contacting a touch-screen interface. For example, tapping a portion of the screen, touching a portion of the screen and then dragging the touched portion in a particular direction, etc. The computer 300 monitors gestures made by the user and converts them into commands (e.g., dismiss, maximize, scroll, etc.) The graphics adapter 312 displays images and other information on the display 318. The network adapter 316 couples the computer 300 to one or more computer networks, such as network 101.

The computer 300 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 308, loaded into the memory 306, and executed by the processor 302.

The types of computer 300 used by the entities of FIG. 1 can vary depending upon the embodiment and the processing power required by the entity. For example, the server system 110 may include multiple computers 300 communicating with each other through a network to provide the functionality described herein. Such computers 300 may lack some of the components described above, such as graphics adapters 312 and displays 318.

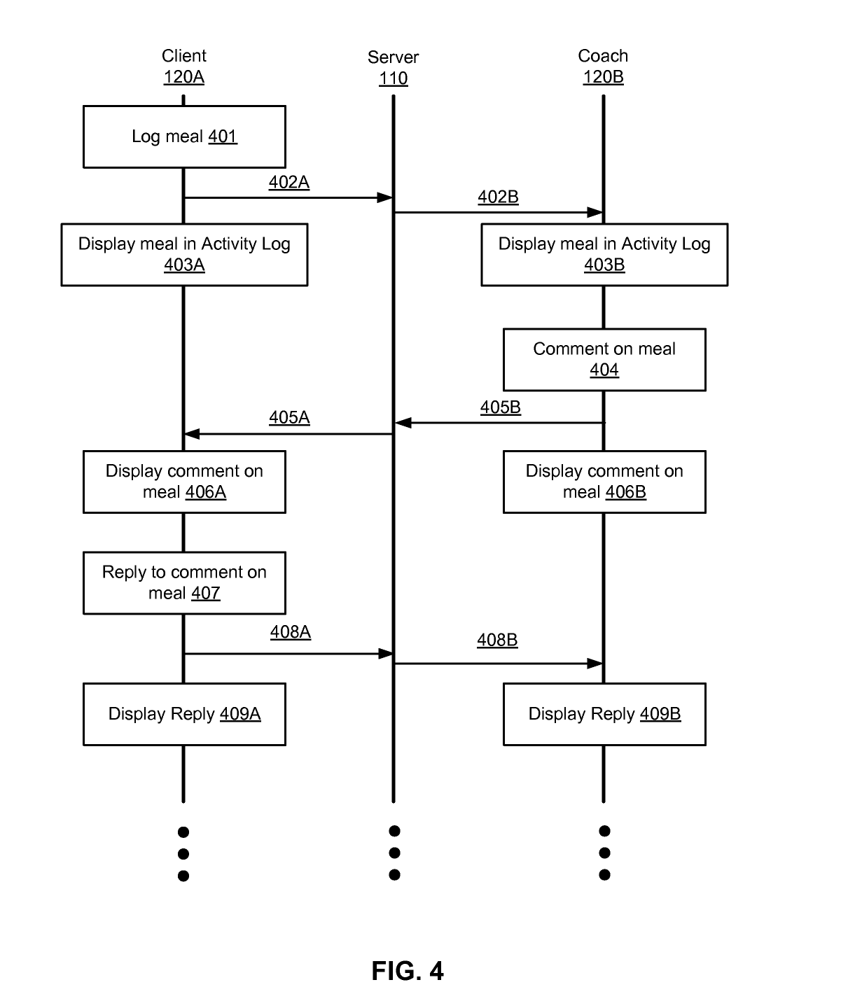

FIG. 4 is a diagram illustrating the interaction between the client 120A, server 110, and coach 120B, according to one embodiment. FIG. 4 illustrates the interaction between the client 120A and the coach 120B by logging a meal, although exercise or activity details can be logged in a similar manner and steps similar to those described below for a log of a meal can be taken for exercise or activity logs. First, the client 120A logs a meal 401, for example by uploading one or more photos of the meal using the photo module 124 of the meal logging module 123 of the application 121A. The logged meal is conveyed 402A to the server 110 and relayed 402B to the client's coach 102B. Thus, the logged meal can be displayed in the client's activity log 403A, 403B on both the client's device 120A and the coach's device 120B.

At any later time, the coach may enter a comment on the meal 404, for example through the messaging module 125 of the commenting module 127 of the application 121B. The comment is conveyed 405B to the server 110 and relayed 405A to the coach's client 120A. Thus, the coach's comment on the meal 406A, 406B can be displayed on both the client's device 120A and the coach's device 120B. It is noted that the discussion thread module 204 of the information presentation module 126 of the application 121 can be used to format the coach's comment on the meal 406A, 406B within a thread relating to the original post of the meal, and subsequent posts within the same thread are treated similarly. Optionally, the other party can be notified by the new message notification module 205 whenever a new posting is made by a client or the client's coach. Thus, the other party can focus on the latest interactions the client or the client's coach has had on the platform.

Again, at any later time, the client may enter a reply to the coach's comment on the meal 407. The reply is conveyed 408A to the server 110 and relayed 408B to the client's coach 102B. Thus, the client's reply 409A, 409B can be displayed on both the client's device 120A and the coach's device 120B. Optionally, when the coach next accesses the application 121B, the coach is notified of the new message, along with any other new messages or logged meals. Accordingly, it is not necessary for the client and the coach to be simultaneously accessing the meal logging platform 100 in order to be engaged in meaningful coaching exchanges on a micro-coaching per meal basis.

FIG. 5 is a set of user interface examples that illustrate logging a meal, in accordance with an embodiment. In user interface example 551, a meal frame is illustrated in the top half of the activity log. If the client selects “LOG MEAL” the client navigates to user interface example 552 where the client can optionally take a photo of the meal or access a library link to choose an existing photo to load as the image of the logged meal. The image selection interface is illustrated in user interface example 553. By selecting the “back” button, the client navigates back to choosing whether to take a photo or use an existing image from the library. By selecting the “next” button, the client accesses the user interface example 554 in which the client can optionally add a text description of the client's meal next to a thumbnail of the image the client selected to be the image of the logged meal. Once completed, the client can select the check mark in the top right corner to complete the process of logging the meal into the client's activity log. By selecting the “x” in the top left corner, the client may be returned to the user interface example 551.

User interface example 555 illustrates the screen after the client selects an existing logged meal to open a message thread corresponding to the logged meal. This example includes a comment area where a client can include commentary on the meal or reply to comments provided by the coach on the meal, which may appear below the image of the meal in the user interface example 555.

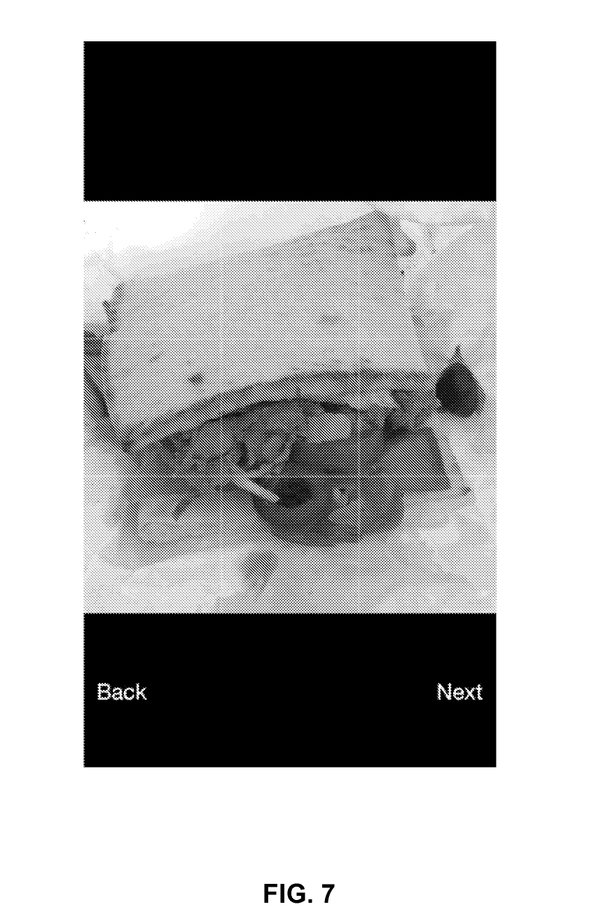

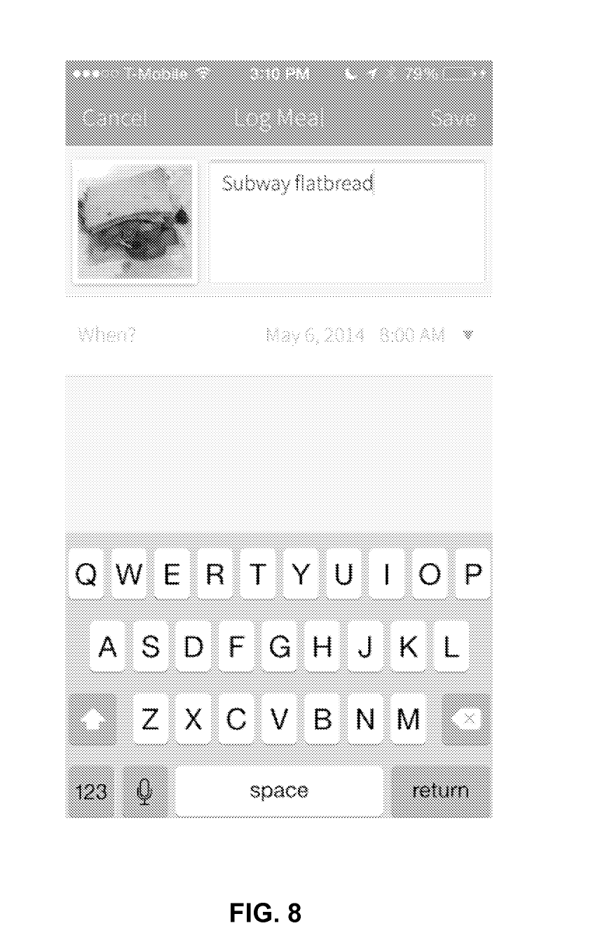

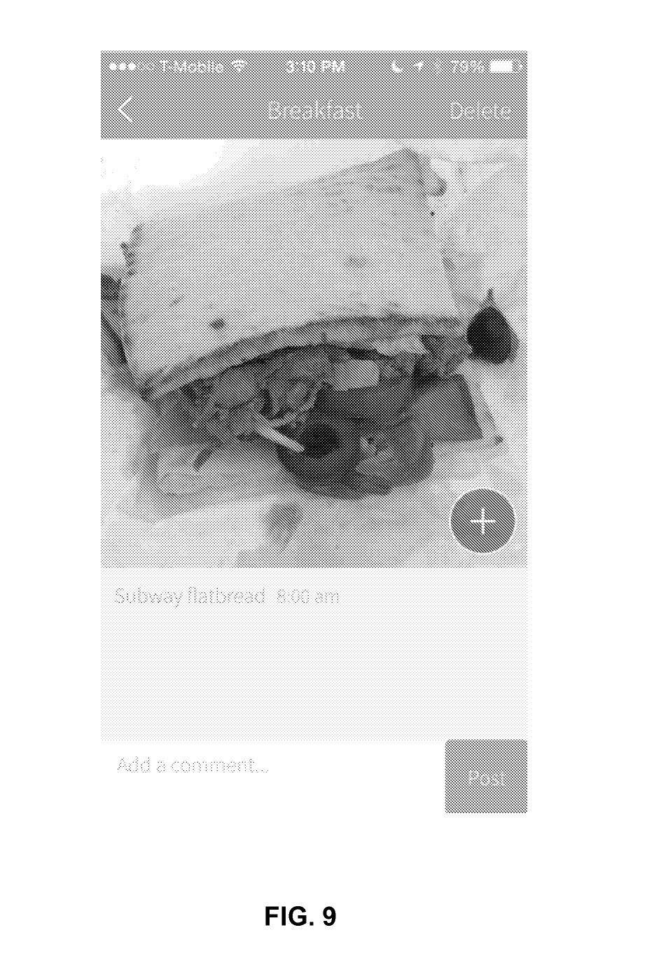

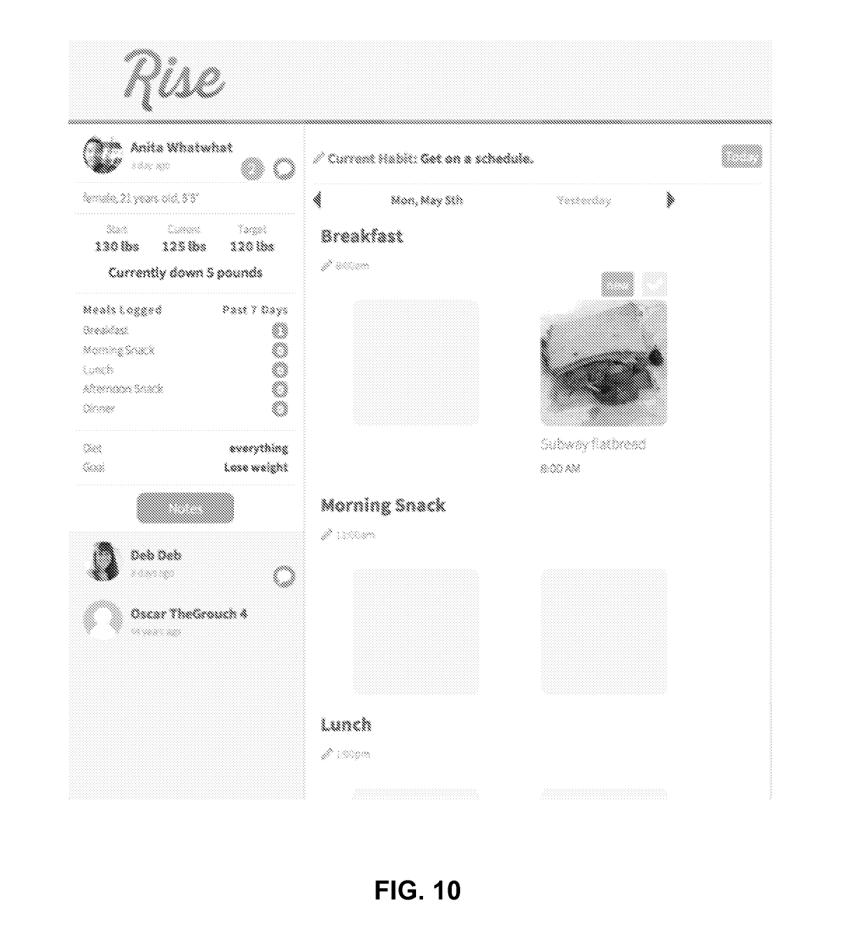

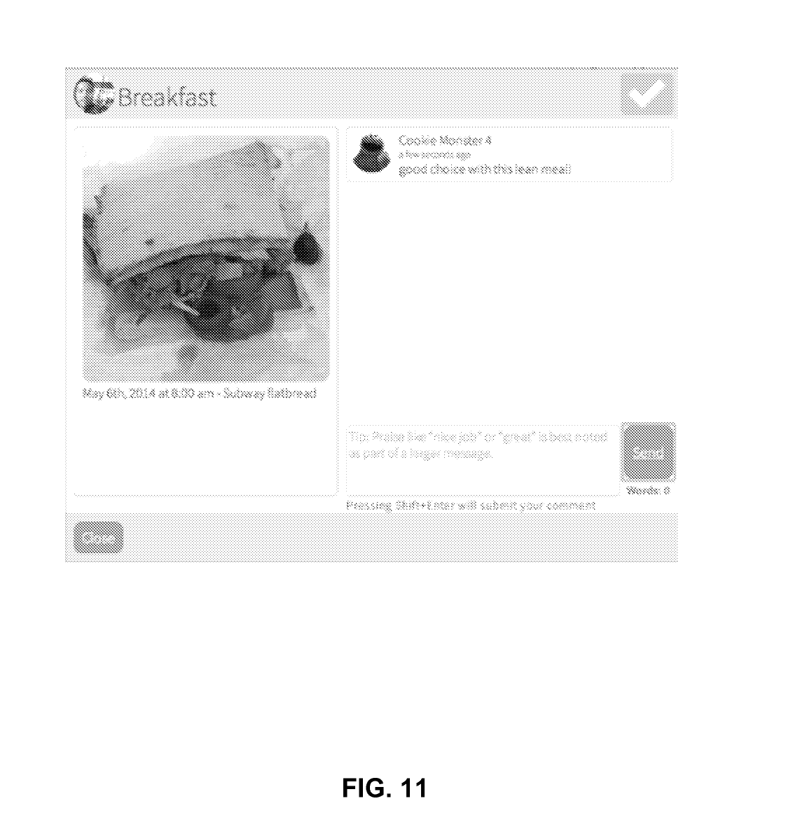

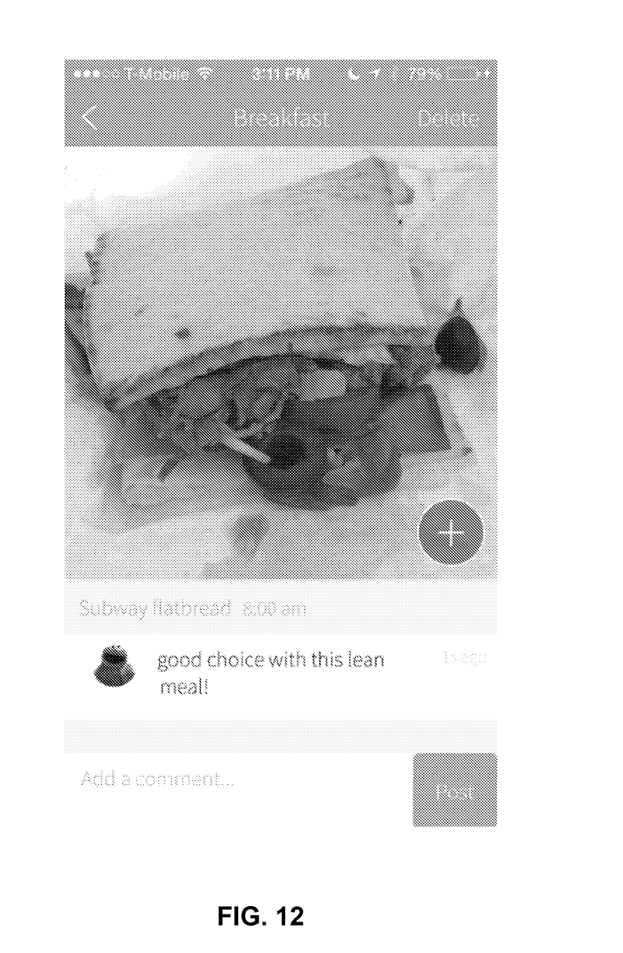

FIGS. 6-12 illustrate another set of user interface examples. FIG. 6 illustrates an example activity log before a client has logged a meal. FIG. 7 illustrates an example user interface for selecting a photo to represent a meal to be logged by the client. FIG. 8 illustrates an example user interface for entering a text description associated with a meal logged by the client. In this example, the user can also select when (in terms of date and time) the meal was consumed. FIG. 9 illustrates an example of a client's view of the meal after it has been logged. FIG. 10 illustrates an example of coach's view of the meal logged by the client as described with reference to FIGS. 7-9. FIG. 11 illustrates an example user interface for a coach to enter feedback on the client's logged meal. Lastly, FIG. 12 illustrates an example of a client's view of the coach's feedback on the client's logged meal. As discussed above, the client can optionally continue the discussion related to this meal by posting a comment to this message thread.

The described platform and application enable clients to obtain coaching toward healthy eating habits on a meal by meal basis through a convenient image-based interface, without confining when or where a client can request feedback or a coach can deliver it. As a result, coaching services can be more efficiently delivered, which lowers the transaction costs of the business, which benefits both clients and coaches.

### Additional Configuration Considerations

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

What is claimed is:

1. A method, implemented on a client device, for logging a client's health, the method comprising:
identifying a plurality of meal slots, each meal slot associated with a time of day and a meal activity and including a conversation thread;
receiving an image for a designated meal slot, the image associated with the meal activity of the designated meal slot;
sending the image associated with the meal activity to a coach device;
receiving, from the coach device, a comment associated with the meal activity;
generating a meal log that includes the image associated with the meal activity and the received comment;
associating the meal log with the designated meal slot; and
displaying the plurality of meal slots in a plurality of frames, including the image and comment associated with the meal log for the meal slot.

2. The method of claim 1, further comprising sending a location associated with the meal activity to the coach.

3. The method of claim 2, wherein the location associated with the meal activity indicates a restaurant.

4. The method of claim 1, further comprising:
receiving exercise details for a designated exercise slot;
sending the exercise details for the designated exercise slot to the coach device;
receiving, from the coach device, a comment on the exercise details;
adding the comment to a conversation thread for the exercise slot; and
displaying the exercise slot in a frame of the plurality of frames, including the comment and the exercise details for the designated slot.

5. The method of claim 1, further comprising displaying the plurality of frames in a calendar interface wherein each frame is associated with a calendar day.

6. The method of claim 1, further comprising:
receiving a client comment associated with the meal activity;
adding the client comment to the conversation thread of the meal log of the designated meal slot;
sending the client comment to the coach device; and
displaying, in association with the meal log, the conversation thread for designated frame in chronological order.

7. The method of claim 1, further comprising:
receiving an evaluation from the coach device regarding whether or not the meal activity of the designated slot conforms to a certain goal; and
displaying the evaluation in association with the meal log of the designated slot and the goal.

8. A method, implemented on a coach device, for providing feedback to a client device, the method comprising:
identifying a plurality of meal slots, each meal slot associated with a time of day and a meal activity and a conversation thread;
receiving, from the client device, an image for a designated meal slot, the image associated with the meal activity of the designated meal slot;
sending, to the client device, a comment associated with the meal activity;
generating a meal log that includes the image of the meal and the comment;
associating the meal log with the designated meal slot; and
displaying the plurality of meal slots in a plurality of frames, including the image and comment associated with the meal log for the meal slot.

9. The method of claim 8, further comprising receiving, from the client device, a location associated with the meal activity.

10. The method of claim 9, wherein the location associated with the meal activity indicates a restaurant.

11. The method of claim 8, further comprising displaying the plurality of frames in a calendar interface wherein each frame is associated with a calendar day.

12. The method of claim 8, further comprising:
receiving, from the client device, a client comment associated with the meal activity of the designated meal slot;
adding the client comment to the conversation thread of the designated meal slot; and
displaying, in association with the meal log, the conversation thread for the designated frame in chronological order.

13. The method of claim 8, further comprising:
receiving exercise details for a designated exercise slot, from the client device;
sending a comment on the exercise details to the client device;
adding the comment to a conversation thread for the exercise slot; and
displaying the exercise slot in a frame of the plurality of frames, including the comment and the exercise details for the designated slot.

14. The method of claim 8, further comprising:
receiving an evaluation regarding whether or not the meal activity of the designated slot conforms to a certain goal;
sending the evaluation to the client device in association with the meal slot and the goal; and
displaying the evaluation in association with the meal log of the designated slot and the goal.
